(19) United States
(12) Patent Application Publication
(10) Pub. No.: US 2016/0107906 A1
(43) Pub. Date: Apr. 21, 2016

(54) POLY ALUMINIUM-SILICATE COMPOSITIONS AND PROCESSES FOR PRODUCING THE SAME

(71) Applicant: BOLLERUP JENSEN A/S, Tarm (DK)

(72) Inventors: Michael Østerby, Vejle (DK); Bent Larsen, Horsens (DK)

(21) Appl. No.: 14/895,358

(22) PCT Filed: Jun. 4, 2014
(86) PCT No.: PCT/DK2014/050156

§ 371 Date: Dec. 2, 2015

(30) Foreign Application Priority Data
Jun. 4, 2013 (DK) PA 2013 70306
Apr. 29, 2014 (DK) PA 2014 70250

(51) Int. Cl. C02F 1/52; C01B 33/26

(52) U.S. Cl. CPC C02F 1/5245; C01B 33/26

(57) ABSTRACT

The present invention relates to an improved poly aluminium-silicate composite composition, an improved method for preparing said composition as well intermediate poly silicate and aluminium-silicate compositions and their preparation. Moreover, the present invention relates to the use of a said poly aluminium-silicate composition as a coagulant in purification of water, such as drinking water or waste water.

### TECHNICAL FIELD OF THE INVENTION

The present invention relates to an improved poly aluminium-silicate composite composition, an improved method for preparing said composition as well as intermediate poly silicate and aluminium-silicate compositions and their preparation. Moreover, the present invention relates to the use of a said poly aluminium-silicate composite composition as a coagulant in purification of water, such as drinking water or waste water.

### BACKGROUND OF THE INVENTION

It is well known from the art that coagulation can be used in water treatment or purification. Thus, coagulation can be used for destabilizing dissolved and colloid organic or inorganic impurities by producing floc polymer aggregates, which can subsequently be removed from the water using filtration or clarification. Poly aluminium-silicate composite compositions, which is a partly polymerized Al(III)-Si composition containing a range of polymeric species, has proven to be very useful in water treatment. Thus, it has proven to improve the aggregating efficiency and give better coagulating effects as compared to for instance hydroxylated poly aluminium chloride (PAC).

Conventionally, poly aluminium-silicate compositions, in particular poly aluminium-silicate chloride (PASC) compositions, have been prepared using a water glass solution, e.g. based on sodium silicate, and an aluminium salt, such as AlCl₃, as starting materials.

Gao et al., Chemosphere 46 (2002), pages 809-813, teaches to prepare a PASC composition starting from a water glass having a SiO₂ concentration of 0.5 M. In the article it is stated that the water glass solution is neutralized to pH 2.0 with 0.5 M HCl under stirring to obtain a poly silicate (or poly silic acid) composition (0.3187 M). Then, 2.09-6.28 ml of the obtained poly silicate solution is mixed with 40 ml 0.25 M aluminium chloride solution and measured amounts of distilled water. Subsequently, 20-50 ml 0.5 M NaOH is added in order to prepare PASC solutions having 0.1M Al and different Si concentrations from 0.0067 to 0.05 M giving rise to different Al/Si ratios of 5-15 and B values (OH/AL ratio) of 1.0-2.5.

Zheng et al., Colloids and Surfaces A: Physicochem. Eng. Aspects 312 (2008), pages 238-244, teaches a PASC composition for use in water purification and a method for its preparation. In the process, a poly silicate or poly silic acid solution was first prepared by adding 23.5 ml 1.5 M HCl into 50 ml 0.5 M SiO₂ while mixing rapidly. The pH was adjusted to 2 to yield 0.329 M poly silicate solution. Subsequently, 23.92 ml de-ionized water was added to 40 ml 0.25M AlCl₃. Depending on the required AL/SI ratio, 6.08 ml poly silicate solution was added and subsequently 40 mL 0.5 M NaOH was solely added to reach the specific B value allowing for metal-silicate polymerization.

Gao et al., Water Research 36 (2002), pages 3573-3581, teaches to prepare PASC compositions as follows. At first, 10.75 ml concentrated waterglass solution (typically 3 M SiO₂) is introduced slowly into 10 ml 2M hydrochloric acid solution under stirred conditions to obtain a poly silicate solution. Allegedly, the poly silicate solution shows the following properties: 1.555M SiO₂ having a pH of 2.0-2.5. The second step is allegedly to either 1) mix the fresh poly silicate solution with 2.5 M AlCl₃ at a Al/Si ratio of 10 or more before adding concentrated Na₂CO₃ to obtain different basicities; or 2) by first slowly adding the concentrated Na₂CO₃ solution into the ALCl₃ under thorough stirring to obtain poly aluminium chloride having different B values (typically 7.70% Al₂O₃), then combine the PAC with the fresh poly silicate solution to obtain PASC coagulants having an Al/Si ratio of 10 or more.

However, as is evident from the experimental examples of the present invention, it is not possible to prepare a liquid poly silicate composition having a concentration of 1.555M SiO₂ and a PH of 2.0-2.5, starting from a 10.75 ml 3M water glass solution and 10 ml 2 M HCl (see example 7 below).

A drawback of the conventional method is that the pH of the initial water glass solution is lowered by using an aqueous HCl solution, which dilutes the water glass solution, giving rise to a PASC composition having a low silicate (Si) concentration. In addition, the lowering of the pH should be performed rather quickly in order to avoid flocculation, which is a particular problem with concentrated silicate solutions. Finally, the use of aqueous acid renders it problematic to prepare the polysilicate intermediate and accordingly the resulting poly aluminium-silicate composition in a continuous process.

Thus, the prior art do not teach anything in relation to how to solve these drawbacks and how to prepare highly concentrated liquid PASC composition as well as highly concentrated liquid poly silicate and poly aluminium-silicate compositions serving as intermediates thereof.

### SUMMARY OF THE INVENTION

Thus, it is an object of the present invention to provide an improved concentrated liquid poly aluminium silicate composite (preferably PASC) composition as well as liquid poly aluminium-silicate and poly silicate compositions, which are intermediates or PRECURSOR compositions to the final composition (preferably PASC).

Thus, one aspect of the invention relates to a liquid poly aluminium-silicate composite composition comprising
0.06-1.5 M SiO₂
0.06-2.0 M aluminium in the form of Al₂O₃
an Al/Si ratio in the range 2-20; and
a basicity (OH/Al molar ratio) (B) in the range from 1 to 10.

Another aspect relates to a liquid poly aluminium-silicate chloride (PASC) composition comprising
0.025-1.5 M silicium (Si);
0.05-2.0 M aluminium (Al);
an Al/Si molar ratio in the range 2-20; and
a pH in the range 10-14.

Another aspect of the invention relates to a liquid poly aluminium-silicate chloride (PASC) composite composition comprising
0.02-1.5 M SiO₂
0.02-2.0 M aluminium in the form of Al₂O₃
an Al/Si ratio in the range 2-20; and
a basicity (OH/Al molar ratio) (B) in the range from 1 to 10.

Yet aspect relates to a liquid poly aluminum-silicate chloride (PASC) composition comprising
0.15-1.5 M silicium (Si);
0.3-3.0 M aluminium (Al);
having an Al/Si molar ratio in the range from 2 to 20; and
a pH in the range from 0 to 3.

Another aspect of the present invention relates to a liquid poly aluminium-silicate composition comprising
0.15-1.5 M silicate salt; and
0.15-2.0 M aluminium in the form of Al₂O₃
having an Al/Si ratio in the range from 2 to 20, and
a pH in the range from 0 to 3.

Yet another aspect of the present invention is to provide a liquid poly silicate composition comprising
0.5-2.0 M SiO₂; and
having a pH in the range from 0 to 3.

An additional aspect relates to a liquid poly silicate composition comprising
0.5-2.0 M silicium (Si); and
having a pH in the range from 0 to 3.

It is also an object of the present invention to provide an improved method of preparing a concentrated liquid poly aluminium silicate composite (PASC) composition and intermediates or PASC PRECURSOR compositions thereof.

Thus, a further aspect of the invention is a process of producing a liquid poly aluminium silicate composite (PASC) composition comprising
1) providing a silicate solution;
2) lowering the pH of said silicate solution by a gaseous acid to a pH in the range from 0 to 3;
3) adding an aluminium source to the silicate solution;
4) raising the pH to above 11 by the addition of a base; and
5) providing a PASC composition.

Yet another aspect of the invention is a process of producing a poly aluminium-silicate composition according comprising
1) providing a silicate solution;
2) lowering the pH of said silicate solution by a gaseous acid to a pH in the range from 0 to 3;
3) adding an aluminum source to the silicate solution; and
4) providing a poly aluminium-silicate composition.

Still another object is a to a process for preparing a poly silicate composition comprising
1) providing a silicate solution;
2) lowering the pH of said silicate solution by a gaseous acid to a pH in the range 0 to 3; and providing a poly silicate composition.

Yet another aspect relates to a process for preparing a poly silicate composition, the process comprising
1) providing a silicate solution,
2) lowering the pH of said silicate solution by a gaseous acid to a pH in the range 0 to 3, providing a liquid poly silicate composition comprising 0.5-2.0 M Si and having a pH in the range from 0 to 3.

Finally, it is an object according to the present invention to use the novel liquid PASC composition for water purification.

### BRIEF DESCRIPTION OF THE FIGURES

FIG. 1 shows a flow diagram of the continuous process according to the present invention, wherein a waterglass or silicate solution is continuously supplied to a container, in which the pH is maintained in the range 0-2 using a stream of HCl gas, subsequently, the acidified waterglass solution is mixed with an aluminium source, such as AlCl₃, in a subsequent chamber followed by raising the pH to above pH 11 using a common base, such as NAOH, under giving the final PASC composition. All the steps are performed under stirring.

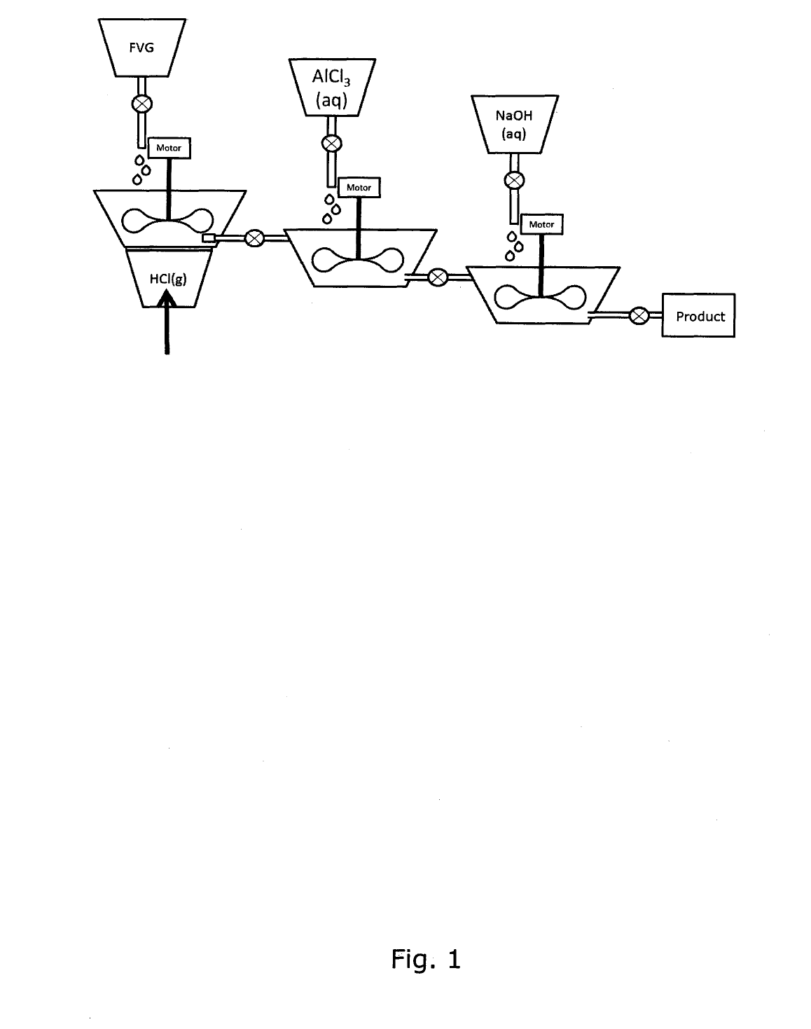

FIG. 2 shows turbidity of lake water as a function of time, using PASC of composition 3 or PAX-XL60.

FIG. 3 shows UV-absorbans of lake water as a function of time, using PASC of composition 3 or PAX-XL60.

FIG. 4 shows the effect of PASC of composition 4, PAX and ironsulphate (jernsulfat) on clearing natural lake water.

FIG. 5 shows the turbidity of lake water as a function of time, using different concentrations of PASC of composition 5.

The present invention will now be described in more detail in the following.

### DETAILED DESCRIPTION OF THE INVENTION

### Definitions

Prior to discussing the present invention in further details, the following terms and conventions will first be defined:

PASC

In the present context PASC refers to “polyaluminium silicate chloride” The term “liquid PASC composition” means, in the context of the present invention, a poly aluminium-silicate composite composition, which is in liquid form, i.e. free from visible coagulants of poly aluminium silicate or silicate particles that may otherwise be formed when using conventional methods of preparing PASC compositions, as also mentioned above.

The terms “intermediate(s)” or (PASC) “PRECURSOR composition(s)” means intermediate(s)/PASC PRECURSOR composition(s) prepared as intermediates in the process according to the present invention for producing the final liquid composition, i.e. liquid concentrated poly silicate and polyaluminium-silicate compositions, respectively.

Aluminium

The term “aluminium” or “aluminium source” for use in the process and compositions according to the present invention is an aluminium(III)ion and/or aluminium(III)salt as also further specified below.

Basicity

The basicity or B-value (also known as the γ value) is defined as the molar [OH]/[Al] ratio of the liquid PASC composition. The B-value has been shown to be important in relation to the coagulation efficiency and stability of the PASC composition. Thus, the coagulation efficiency is increased with increasing B-value.

Al/Si ratio

The Al/Si ratio is defined as the molar [Al]/[Si] ratio also important in relation to the coagulation efficiency of the liquid PASC composition and has been shown to provide optimal coagulation efficiency when the PASC composition has a Al/Si ratio in the range between 5 and 15.

### Preferred Embodiments

Conventionally, poly aluminium-silicate composite compositions, in particular poly aluminium-silicate chloride (PASC) compositions, and PASC PRECURSOR or intermediate compositions have been prepared using a water glass solution, e.g. based on sodium silicate, which are acidified to pH 1-3 using an aqueous acid, such as a HCl solution and, subsequently, adding an aluminium (III) salt, such as AlCl₃. Finally, the pH is raised using a conventional base, such as sodium hydroxide (NaOH).

Thus, Gao et al., Chemosphere 46 (2002), pages 809-813, teaches to prepare a PASC composition starting from a water glass having a SiO₂ concentration of 0.5 M. The water glass solution is acidified to pH 2.0 with 0.5 M HCl under stirring to obtain a poly silicate (or poly silic acid) composition (0.3187 M). Then, 2.09-6.28 ml of the obtained poly silicate solution is mixed with 40 ml 0.25 M aluminium chloride (AlCl₃) solution and measured amounts of distilled water. Subsequently, 20-50 ml 0.5 M NaOH is added in order to prepare poly aluminium-silicate composite (PASC) solutions having 0.1M Al and different Si concentrations from 10 0.0067 to 0.05 M giving rise to different Al/Si ratios of 5-15 and B values (OH/AL ratio) of 1.0-2.5.

The drawbacks of the conventional process for preparing PASC and PASC PRECURSOR compositions is, as mentioned above, that the silicate concentration in the resulting composition is low due to the diluting effect of the aqueous acid. Moreover, there is a high risk of coagulation of the composition, when prepared in large scale and when starting from a water glass solution having a formal silicate concentration above 0.5M. Consequently, it is difficult to use the conventional method in a continuous process and in an industrial scale, when more concentrated PASC compositions are to be produced.

Processes

In contrast to the conventional methods, the processes according to the present invention can advantageously be conducted in a continuous manner and on large industrial scale with more concentrated silicate solutions.

Hence, according to one aspect of the present invention the process according to the present invention may essentially be performed as outlined below. Firstly, a silicate solution is provided having a formal Si concentration of 0.2-2.0 M, preferably 1.0 M (step 1), is added to a container, where controlled addition is possible. In step 2), the solution is slowly added to a reaction chamber, where the pH is maintained in the range 0-3, preferably 0-2, in order to prevent formation of silica gels. Control of pH can be maintained via a pH electrode and a stream of HCl gas, which can be administered via a filter placed in the bottom of the reaction chamber. This configuration, in combination with efficient stirring and control of the volumetric flow rate of water glass addition, facilitates the safe formation of an acidified water glass composition with no impurities or precipitates in a continuous manner. The reaction chamber is fitted with an outlet, which can be opened to keep the volume in the reaction chamber constant during continuous production of the acidified silicate composition. subsequently, in a second reaction chamber, the resulting acidified poly silicate composition is added to an aluminium (III) salt solution having a formal Al concentration of 1-3 M, preferably 2M, more preferably based on AlCl₃, as an aluminium source in solution, is added by liquid-liquid mixing, using an Al concentration calculated to reach a molar Al/Si ratio of 4-20 in the product mixture (step 3).

Finally, in a third reaction chamber, the resulting acidic poly aluminium silicate PASC PRECURSOR composition can be mixed with a conventional base, such as (KOH, NaOH or derivatives thereof) to obtain the final liquid poly aluminium-silicate composition having a pH≧11 and an OH/Al ratio in the range of 1-20 (step 4). Thus, yet an aspect of the present invention relates to a process for preparing a poly silicate composition, the process comprising
1) providing a silicate solution,
2) lowering the pH of said silicate solution by a gaseous acid to a pH in the range 0 to 3, providing a liquid poly silicate composition comprising 0.5-2.0 M Si and having a pH in the range from 0 to 3.

In an embodiment the process further comprises a step 3), said step 3) comprising
3) adding an aluminium source to the composition provided in step 2; providing a liquid poly aluminium-silicate composition comprising
   0.15-1.5 M silicate;
   0.15-2.0 M aluminium;
   having an Al/Si molar ratio in the range from 2 to 20, and
   a pH in the range from 0 to 3.

In yet an embodiment the process further comprises a step 4), said step 4) comprising
4) raising the pH to above 11 in the composition provided in step 3) by the addition of a base, providing a liquid poly aluminium silicate composite comprising
   0.02-1.5 M Silicate (Si);
   0.02-2.0 M Aluminium (Al);
   an Al/Si molar ratio in the range 2-20; and
   a basicity (OH/Al molar ratio) (B) in the range from 1 to 10.

In a preferred embodiment, the process includes step 2, step 3 and step 4. As outlined above, including step 2 results in a first intermediate product, step 3 results in a second intermediate product and step 4 results in a final product, which may find use as a coagulant e.g. for water purification (see example section).

In an embodiment, the silicate is selected from the group consisting of sodium silicate, potassium silicate and lithium silicate, preferably sodium silicate.

It is an object of the invention to keep a high concentration of Si during the production process. The concentration of the liquid polysilicate provided in step 2 may vary. Thus, in an embodiment the concentration of silicate in the provided liquid polysilicate in step 2) is 0.6-1.5M, such as 0.7-1.5M, such as 0.8-1.5M, such as 0.9-1.5M, such as 1-1.5M, such as 1.1-1.5 M, such as 1.2-1.5M, such as 1.3-1.5M, or such as 1.4-1.5M.

Similar, the concentration of the liquid polyaluminium silicate provided in step 3 may vary. Thus, in a further embodiment the concentration of silicate in the provided liquid polyaluminium silicate in step 3) is 0.2-1.5M, 0.25-1.5M, such as 0.3-1.5M, such as 0.35-1.5M, such as 0.4-1.5M, such as 0.45-1.5M, such as 0.5-1.5M, such as 0.6-1.5M,such as 0.7-1.5M, such as 0.8-1.5M, such as 0.9-1.5M, such as 1-1.5M, such as 1.1-1.5 M, such as 1.2-1.5M, such as 1.3-1.5M, such as 1.4-1.5M.

Finally, the concentration of the liquid polyaluminium silicate provided in step 4 may vary 27. The process according to any of claims 23-26, wherein the concentration of silicate in the provided liquid polyaluminium silicate in step 4) is 0.2-1.5M, 0.25-1.5M, such as 0.3-1.5M, such as 0.35-1.5M, such as 0.4-1.5M, such as 0.45-1.5M, such as 0.5-1.5M, such as 0.6-1.5M,such as 0.7-1.5M, such as 0.8-1.5M, such as 0.9-1.5M, such as 1-1.5M, such as 1.1-1.5 M, such as 1.2-1.5M, such as 1.3-1.5M, such as 1.4-1.5M.

It may be preferable to avoid SO₄²⁻ in the compositions, especially since AlCl₃ is a preferred source of aluminium. Thus, in an embodiment, the molar ratio between Cl⁻ and SO₄²⁻ in the composition provided in step 3) and/or step 4) is at least 10:1, such as at least 100:1 such as at least 1000:1, such as at least 10000:1, such as at least 100000:1.

For industrial scale production, it is important to optimize the process. Thus, in an embodiment the process is conducted in a continuous flow.

The basicity in the final composition may also vary depending on the concentrations of the used components. In yet an embodiment the basicity in the composition provided in step 4) is 1-9, such as 1-8, 1-7, 1-6, 1-5, 1-4, 1-3, 1-2 or such as 1.5-10, 2-10, 3-10, 4-10, 5-10, 6-10, 7-10, 8-10, 9-10 or such as 1.5-2.5.

In a similar embodiment the H in the composition provided in step 4) is 10-14, 11-14, 12-14, or 13-14.

In yet a similar embodiment the Al/Si ratio in the composition provided in step 4) is 3-20, such as 4-20, such as 5-20, 6-20, such as 7-20, such as 8-20, such as 9-20, such as 10-20, such as 2-19, such as 2-18, 2-17, 2-16, 2-15, 2-14, 2-13, 2-12, 2-11, or 2-10.

As previously mentioned, the source of Al may vary. In another embodiment the aluminium source added in step 3) is selected from the group consisting of Al₂O₃, Al₂(SO₄)₃, AlCl₃, MAl(OH)ₓY, wherein M is a an alkali metal or earth alkali metal cation, X is the number of OH— groups and Y is an anion such as SO₄²⁻, Cl⁻, F⁻, PO₄³⁻. Preferably, the aluminium source is AlCl₃.

The aluminium concentration in the compositions provided in step 3 and 4 should also have an optimal concentration. Thus, in yet a further embodiment, the aluminium concentration in the provided liquid poly aluminium-silicate composition provided in step 3 and/or 4 is 0.25-2M, such as 0.3-2M, such as 0.35-2M, such as 0.4-2M, such as 0.45-2M, such as 0.5-2M, such as 0.6-2M, such as 0.7-2M, such as 0.8-2M, such as 0.9-2M, such as 1-2M, such as 1.1-2M such as 1.2-2M, such as 1.3-2M, such as 1.4-2M, or 1.5-2.0M.

Different sources of gaseous acid may be used to lower the pH. Therefore, in an embodiment the gaseous acid is selected from the group consisting of HCl, H₂SO₄, HNO₃, SO₃, SO₂, N₂O₅, and NO₂, preferably HCl.

The process is preferably conducted at room temperature.

Hence, it is evident, as compared to the prior art processes, that the process according to the present invention provides for the possibility of using higher Si concentrations of the waterglass or silicate solution used as the starting material and even so avoiding coagulation when acidifying the concentrated silicate composition by using a gaseous acid to obtain a concentrated poly silicate composition.

Thus, in particular, the use of a gaseous acid in the acidification step of the process according to the present invention provides several advantages. Firstly, the use of gaseous acid surprisingly renders it possible to use a more concentrated silicate solution as the starting point without the problems of coagulation as mentioned in relation to the prior art process when using an acid in solution. Secondly, by using a gaseous acid for acidification, the concentration of the resulting poly silicate composition and, consequently, the final poly aluminium-silicate composite composition is even higher due to the fact that the gaseous acid will not dilute the resulting acidified poly silicate composition to the same extent as if an acid solution was used to acidify the silicate solution. Thirdly, as also mentioned above, the use of a gaseous acid is much more suitable for producing poly aluminium-silicate composite compositions in a continuous manner and on a large industrial scale due to the fact that the process can be controlled much more precisely and because as mentioned above, it has surprisingly been realised that the use of gaseous acid for acidification of the starting silicate solution minimizes the formation of poly silicate coagulates at both high and low SiO₂ concentrations, which is desirable in the process as well as in the final (PASC) composition.

Thus, the poly silicate and poly aluminium silicate compositions prepared by the present novel process according to the invention provides poly silicate and poly aluminium silicate compositions with a very low overall content of coagulates, which renders the compositions more stable towards spontaneous coagulation during storage and provides better coagulating properties when for instance used for water purification. Moreover, the inventor has found that the stability provided by the process according to the present invention is even more important when concentrated poly silicate or poly aluminium-silicate compositions, which have a higher tendency to coagulate during storage.

Moreover, the more concentrated poly silicate and poly aluminium-silicate compositions provided according to the the present invention have a correspondingly higher coagulating capacity, which combined with the increased stability, renders the compositions particularly suitable for industrial purposes, such as a coagulant in water treatment.

Thus, the present invention relates to an improved process for producing the novel liquid PASC compositions according to the present invention in a continuous manner. Thus, in another aspect, the present invention provides a process of producing a liquid poly aluminium silicate composite (PASC) composition comprising
1) providing a silicate solution;
2) lowering the pH of said silicate solution by a gaseous acid to a pH in the range from 0 to 3, followed by
3) adding an aluminium source to the silicate solution,
4) raising the pH to above 11 by the addition of a base, providing a PASC composition.

In another aspect, the present invention relates to a process of producing a poly aluminium-silicate composition comprising
1) providing a silicate solution,
2) lowering the pH of said silicate solution by a gaseous acid to a pH in the range from 0 to 3,
3) adding an aluminum source to the silicate solution, and providing a poly aluminium-silicate composition.

In yet another aspect, the present invention relates to a process for preparing a poly silicate composition comprising
1) providing a silicate solution,
2) lowering the pH of said silicate solution by a gaseous acid to a pH in the range 0 to 3, providing a poly silicate composition.

The silicate solution in step 1) of the processes may be prepared from a salt selected from the group consisting of sodium silicate, potassium silicate and lithium silicate.

The concentration of SiO₂ in the silicate solution may vary depending on the specific preparation. Thus, the concentration of SiO₂ in the silicate solution may be 0.2-2M, such as 0.3-2M, such as 0.4-2M, such as 0.5-2M, such as 0.6-2M, such as 0.7-2M, such a 0.8-2M, such as 0.9-2M, 1-2M, such as 1.1-2M, such as 1.2-2M, such as 1.3-2M, such as 1.4-2M, such as 1.5-2M, such as 1.6-2M, such as 1.7-2M, such as 1.8-2M, such as 1.9-2M. In another embodiment, the concentration of silicate is 0.2-1.9M, such as 0.2-1.8M, such as 0.2-1.7M, such as 0.2-1.6M, such as 0.2-1.5M, such as 0.2-1.4M, 0.2-1.3M, 0.2-1.2M, 0.2-0,2-1.1M, 0.2-1.0M, 0.2-0.9M, 0.2-0.8M, 0.2-0.7M, 0.2-0.6M, 0.2-0.5M, 0.2-0.4M or 0.2-0.3M. In a further embodiment, the concentration of silicate is 0.7-1.9M, 0.8-1.8M, 0.9-1.7M, 1.0-1.5 M. In a preferred embodiment the silicate composition is 1.0M.

The gaseous acid used in step 2) of the above processes for lowering the pH may, depending on the wanted properties of the resulting composition, be selected from the group consisting of HCl, H₂SO₄, HNO₃, SO₃, SO₂, N₂O₅, and NO₂. The gaseous acid is preferably HCl. In a further embodiment, the pH of the provided silicate solution in step 1) in the above processes is lowered to a pH in the range 8-10 by a liquid solution of said gaseous acid before step 2).

The aluminium source used in step 3) of the above processes for preparing a liquid PASC composition or a liquid poly aluminium silicate PASC PRECURSOR composition is selected from the group consisting of Al₂O₃, Al₂(SO₄)₃, AlCl₃, MAl(OH)ₓY, wherein M is a an alkali metal, such as sodium, potassium or lithium or earth alkali metal cation, such as magnesium or calcium, X is the number of OH— groups and Y is an anion, such as SO₄²⁻, Cl⁻, F⁻, PO₄³⁻). The aluminium source is preferably AlCl₃.

The base used in step 4) of the above process for preparing a liquid PASC composition is selected from the group consisting of NaOH, KOH, LiOH, Na₂O, K₂O, CaO, MgO, Ca(OH)₂, and Mg(OH)₂.

Compositions Obtained/Obtainable by Process

Even though the properties of the present PASC and PASC PRECURSOR compositions largely can be characterized by their formal concentrations of SI, Al, AL/Si ratio, the B value and/or pH. The PASC and PASC PRECURSOR compositions may under some circumstances advantageously be further characterized according to the methods of preparing said compositions, in particular in relation to the purity and stability of the compositions they may advantageously be characterized according to the process.

Accordingly, in an aspect, the present invention relates to a liquid composition obtainable/obtained by a process according to the present invention, preferably a PASC composition. In another aspect, the present invention relates to a liquid poly aluminum-silicate PASC PRECURSOR composition obtainable by a process according to the present invention. In still another aspect, the present invention relates to a liquid poly silicate PASC PRECURSOR composition obtainable by a process according to the present invention.

The compositions obtained by the processes may have special characteristics. Thus, an aspect of the invention relates to a liquid silicate composition obtained/obtainable by a process according to the invention. Especially a composition obtained after step 2. This product is an intermediate in the production of the coagulant according to the invention and may (as later described, it may find use as an impregnation agent such as for wood impregnation. In yet an aspect the invention relates to a poly aluminium-silicate composition obtained/obtainable by a process terminated after step 3. This product is also an intermediate in the production of the coagulant according to the invention. In yet a further aspect, the invention relates to a poly aluminium-silicate composition obtained/obtainable by a process terminated after step 4. This product is the coagulant according to the invention.

Compositions

As also mentioned above, the present invention relates to novel liquid poly aluminium-silicate composite (PASC) compositions having a higher silicate concentration than conventional types of poly silicate aluminium compositions.

In a first aspect, the present invention relates to a liquid poly aluminium-silicate composite (PASC) composition comprising
0.06-1.5 M SiO₂
0.06-2.0 M aluminium in the form of Al₂O₃
an Al/Si ratio in the range 2-20; and
a basicity (OH/Al molar ratio) (B) in the range from 1 to 10.

In yet an aspect the invention relates to a liquid poly aluminium-silicate chloride (PASC) composition comprising
0.025-1.5 M silicium (Si);
0.05-2.0 M aluminium (Al);
an Al/Si molar ratio in the range 2-20; and
a pH in the range 10-14.

In an embodiment, the source of silicium is a silicate selected from the group consisting of sodium silicate, potassium silicate and lithium silicate, preferably sodium silicate.

In another embodiment the concentration of silicium in the liquid PASC composition is 0.03-1M, such as 0.04-1M, such as 0.06-1M, such as 0.075-1M, such as 0.1-1M, such a 0.15-1M, such as 0.2-1M, 0.25-1M, such as 0.3-1M, such as 0.35-1M, such as 0.4-1M, such as 0.45-1M, such as 0.5-1M, such as 0.6-1M,such as 0.7-1M, such as 0.8-1M, or such as 0.9-1M,

As previously mentioned, it may be advantageously to limit the amount of SO₄²⁻ in the composition. Thus, in an embodiment the molar ratio between Cl⁻ and SO₄²⁻ is at least 10:1, such as at least 100:1 such as at least 1000:1, such as at least 10000:1, such as at least 100000:1. In a related embodiment, the composition is free of or substantially free of SO₄²⁻.

In a further embodiment the aluminium concentration is 0.075-2M, such as 0.1-2M, such a 0.15-2M, such as 0.2-2M, 0.25-2M, such as 0.3-2M, such as 0.35-2M, such as 0.4-2M, such as 0.45-2M, such as 0.5-2M, such as 0.6-2M, such as 0.7-2M, such as 0.8-2M, such as 0.9-2M, such as 1-2M, such as 1.1-2M such as 1.2-2M, such as 1.3-2M, such as 1.4-2M, or 1.5-2.0M.

The composition may be further defined by the Al/Si ratio. Thus, in yet an embodiment the Al/Si ratio is 3-20, such as 4-20, such as 5-20, 6-20, such as 7-20, such as 8-20, such as 9-20, such as 10-20, such as 2-19, such as 2-18, 2-17, 2-16, 2-15, 2-14, 2-13, 2-12, 2-11, 2-10, or such as 5-16, or such as 8-14.

The composition may also be further defined by the basicity. Thus, in yet a further embodiment the basicity (OH/Al molar ratio; (B)) is in the range 1-30, such as 5-30, such as 10-30, such as 15-30, such as 20-30, or such as 1-9, such as 1-8, 1-7, 1-6, 1-5, 1-4, 1-3, 1-2 or such as 1.5-10, 2-10, 3-10, 4-10, 5-10, 6-10, 7-10, 8-10, 9-10 or such as 1.5-2.5. In a related embodiment, the pH of the liquid PASC composition is 11-14, 12-14, or 13-14.

In an embodiment of the present invention, the source of silicium is a silicate salt selected from the group consisting of sodium silicate, potassium silicate and lithium silicate, preferably sodium silicate

The concentration of the silicate in the liquid poly aluminium-silicate composite composition may vary depending on the specific purpose. In an embodiment, the concentration of silicate in the liquid composition is 0.075-1.5M, such as 0.1-1.5M, such a 0.15-1.5M, such as 0.2-1.5M, 0.25-1.5M, such as 0.3-1.5M, such as 0.35-1.5M, such as 0.4-1.5M, such as 0.45-1.5M, such as 0.5-1.5M, such as 0.6-1.5M,such as 0.7-1.5M, such as 0.8-1.5M, such as 0.9-1.5M, such as 1-1.5M, such as 1.1-1.5M such as 1.2-1.5M, such as 1.3-1.5M, such as 1.4-1.5M. In another embodiment, the concentration of silicate is 0.06-1.4M, such as 0.06-1.3M, such as 0.06-1.2M, such as 0.06-1.1M, such as, such as 0.06-1.0M, such as 0.06-0.5M. In a further embodiment, the concentration of silicate is 0.1-1.4M, 0.2-1.3M, 0.3-1.2M, 0.4-1.1M, 0.5-1.0M, 0.6-0.9M, or 0.7-0.8M. In preferred embodiments of the invention the concentration of silicium in the composition is in the range 0.02-1 M, even more preferably 0.021-0.05 M.

The choice of aluminium source will provide different properties to the resulting PASC composition, Thus, in an embodiment, the aluminium source is an aluminium(III)salt. In another embodiment the al is selected from the group consisting of Al₂O₃, Al₂(SO₄)₃, AlCl₃, MAl(OH)ₓY (wherein M is a an alkali metal or earth alkali metal cation, X is the number of OH— groups and Y is an anion such as SO₄²⁻, Cl⁻, F⁻, PO₄³⁻). Preferably, the aluminum source is selected from Al₂O₃, Al₂(SO₄)₃, or AlCl₃. More preferred preferably, AlCl₃.

Also, the specific concentration of aluminium will depend on the specific purpose of the liquid PASC composition. Thus, in an embodiment, the aluminium concentration is 0.075-2M, such as 0.1-2M, such a 0.15-2M, such as 0.2-2M, 0.25-2M, such as 0.3-2M, such as 0.35-2M, such as 0.4-2M, such as 0.45-2M, such as 0.5-2M, such as 0.6-2M, such as 0.7-2M, such as 0.8-2M, such as 0.9-2M, such as 1-2M, such as 1.1-2M such as 1.2-2M, such as 1.3-2M, such as 1.4-2M, or 1.5-2.0M. In another embodiment, the aluminium concentration is 0.06-1.75M, such as 0.06-1.5M, such as 0.06-1.25M, such as 0.06-1.0M, such as, such as 0.06-0.75M, such as 0.06-0.5M. In a further embodiment, the concentration of silicate is 0.1-1.75M, 0.2-1.5M, 0.3-1.25M, 0.4-1.0M, 0.5-1.0M, 0.6-0.9M, or 0.7-0.8M. Preferably, the aluminium concentration is 0.2-1.0 M, even more preferably, the concentration is 0.2-0.5 M.

In a preferred embodiment, the present invention relates to a PASC composition, wherein the silicate concentration is 0.075-0.5M and the aluminium concentration is 0.5-1.5M, such as a silicate concentration of 0.1-0.5M and an aluminium concentration of 0.5-1.0M.

The Al/Si ratio is important to the coagulation properties of the liquid PASC composition and may be adjusted to the specific use as e.g. a coagulant. Thus, in an embodiment the Al/Si ratio is 3-20, such as 4-20, such as 5-20, 6-20, such as 7-20, such as 8-20, such as 9-20, such as 10-20. In another embodiment the Al/Si ratio is 2-19, such as 2-18, 2-17, 2-16, 2-15, 2-14, 2-13, 2-12, 2-11, or 2-10. In a preferred embodiment, the Al/Si ratio is 5-15, even more preferably 8-15, such as 8-12.

The basicity or molar OH/Al ratio, also known as the B-value, of the liquid PASC composition may also vary dependent on the specific use. In an embodiment, the basicity is in the range 1-30, such as 5-30, such as 10-30, such as 15-30, such as 20-30, or such as 1-9, such as 1-8, 1-7, 1-6, 1-5, 1-4, 1-3, 1-2 or such as 1.5-10, 2-10, 3-10, 4-10, 5-10, 6-10, 7-10, 8-10, 9-10 or such as 1.5-2.5. In a preferred embodiment, the basicity is 10-25.

In a further embodiment the pH of the liquid PASC composition is 8-14, such as 9-14, 10-14, 11-14, 12-14, or 13-14. Preferably 12-14, such as 12-13.

In the tables below are preferred compositions according to the invention. These compositions may be considered preferred embodiments of the invention. These embodiments cover the compositions produced and tested in the example section

| Component | Concentration (M), pH and ratios |
|---|---|
| Si (total) | 0.02-0.04M |
| Aluminium (total) | 0.2-0.6M |
| Al/Si molar ratio | 5-16 |
| OH/Al molar ratio (B) | 15-25 |
| pH | 10-14 |

| Component | Concentration (M), pH and ratios |
|---|---|
| Si (total) | 0.025-0.04M |
| Aluminium (total) | 0.2-0.6M |
| Al/Si molar ratio | 8-16 |
| OH/Al molar ratio (B) | 15-25 |
| pH | 10-14 |

PRECURSOR Compositions

The present invention also relates to novel liquid poly silicate PRECURSOR compositions being acidic and having a higher silicate concentration than corresponding known liquid PRECURSOR compositions.

Silicate Composition

Hence, in a second aspect, the present invention relates to a liquid poly silicate composition comprising
0.5-2.0 M SiO₂; and
having a pH in the range from 0 to 3.

In a related aspect the invention relates to a liquid poly silicate composition comprising
0.5-2.0 M silicium (Si); and
having a pH in the range from 0 to 3.

In an embodiment the silicate is a silicate salt selected from the group consisting of sodium silicate, potassium silicate and lithium silicate.

In yet an embodiment the concentration of silicium in the liquid poly silicate composition is 0.6-2M, such as 0.7-2M, such a 0.8-2M, such as 0.9-2M, 1-2M, such as 1.1-2M, such as 1.2-2M, such as 1.3-2M, such as 1.4-2M, such as 1.5-2M, such as 1.6-2M, such as 1.7-2M, such as 1.8-2M, such as 1.9-2M, such as 0.6-1.9M, such as 0.6-1.8M, such as 0.6-1.7M, such as 0.6-1.6M, such as 0.6-1.5M, such as 0.6-1.4M, 0.6-1.3M, 0.6-1.2M, 0.6-1.1M, 0.6-1.0M, 0.6-0.9M, 0.6-0.8M, or 0.6-0.7M, such as 0.7-1.9M, 0.8-1.8M, 0.9-1.7M, 1.0-1.5 M.

In yet a further embodiment the pH of the liquid poly silicate composition is in the range 1-3, such as 2-3, or in the pH range 0-2, such as 0-1 or 1-2.

Poly Aluminum-Silicate Chloride (PASC) Precursor Composition

In yet an aspect the invention relates to a liquid poly aluminum-silicate chloride (PASC) composition comprising
0.15-1.5 M silicium (Si);
0.3-3.0 M aluminium (Al);
having an Al/Si molar ratio in the range from 2 to 20; and
a pH in the range from 0 to 3.

In an embodiment the concentration of silicium in the poly aluminium-silicate composition is 0.2-1.5M, 0.25-1.5M, such as 0.3-1.5M, such as 0.35-1.5M, such as 0.4-1.5M, such as 0.45-1.5M, such as 0.5-1.5M, such as 0.6-1.5M,such as 0.7-1.5M, such as 0.8-1.5M, such as 0.9-1.5M, such as 1-1.5M, such as 1.1-1.5M such as 1.2-1.5M, such as 1.3-1.5M, such as 1.4-1.5M, such as 0.15-1.4M, such as 0.15-1.3M, such as 0.15-1.2M, such as 0.15-1.1M, such as, such as 0.15-1.0M, such as 0.15-0.5M, such as 0.2-1.4M, 0.3-1.3M, 0.4-1.2M, 0.5-1.1M, 0.6-1.0M, 0.7-0.9M, or 0.7-0.8 M.

In another embodiment, the molar ratio in the poly aluminium-silicate composition is between Cl⁻ and SO₄ is at least 10:1, such as at least 100:1 such as at least 1000:1, such as at least 10000:1, such as at least 100000:1. In a related embodiment, the composition is free of or substantially free of SO₄²⁻.

In a further embodiment, the aluminium concentration is 0.3-2.5 M, such as 0.3-2 M, such as such as 0.3-2.0M, such as 0.35-2.0M, such as 0.4-2.0M, such as 0.45-2.0M, such as 0.5-2.0M, such as 0.6-2.0M,such as 0.7-2.0M, such as 0.8-2.0M, such as 0.9-2.0M, such as 1-2.0M, such as 1.1-2.0M such as 1.2-2.0M, such as 1.3-2.0M, such as 1.4-2.0M, or 1.5-2.0M, or such as 0.3-1.75M, 0.5-1.5M, 0.75-1.25M, or 1.0-1.25M. In a related embodiment the Al/Si ratio is 3-20, such as 4-20, such as 5-20, 6-20, such as 7-20, such as 8-20, such as 9-20, such as 10-20, such as 2-19, such as 2-18, 2-17, 2-16, 2-15, 2-14, 2-13, 2-12, 2-11, or 2-10, or such as 5-15.

In yet a further embodiment the pH range is 1-3, such as 2-3, or 0-2, such as 0-1 or 1-2.

In an embodiment of the present invention, the silicate salt in the poly silicate PRECURSOR composition is selected from the group consisting of sodium silicate, potassium silicate and lithium silicate.

The concentration of silicate in the liquid poly silicate composition may vary depending on the specific purpose.

In an embodiment, the concentration of silicate in the liquid poly silicate composition is 0.6-2M, such as 0.7-2M, such a 0.8-2M, such as 0.9-2M, 1-2M, such as 1.1-2M, such as 1.2-2M, such as 1.3-2M, such as 1.4-2M, such as 1.5-2M, such as 1.6-2M, such as 1.7-2M, such as 1.8-2M, such as 1.9-2M. In another embodiment, the concentration of silicate is 0.6-1.9M, such as 0.6-1.8M, such as 0.6-1.7M, such as 0.6-1.6M, such as 0.6-1.5M, such as 0.6-1.4M, 0.6-1.3M, 0.6-1.2M, 0.6-1.1M, 0.6-1.0M, 0.6-0.9M, 0.6-0.8M, or 0.6-0.7M. In a further embodiment, the concentration of silicate is 0.7-1.9M, 0.8-1.8M, 0.9-1.7M, 1.0-1.5 M. In a preferred embodiment, the silicate concentration is 1.0M.

The pH range of the liquid poly silicate PASC PRECURSOR composition may vary depending on the specific further use of the composition. Thus, in an embodiment the pH range is 1-3, such as 2-3 or in the pH range is 0-2, or 0-1. Preferably, the pH range is 1-2. Furthermore, the present invention relates to novel liquid poly aluminium-silicate PASC PRECURSOR composition having a higher silicate concentration than corresponding PASC PRECURSOR compositions.

Hence, in a further aspect, the present invention relates to liquid poly aluminium-silicate composition comprising
0.15-1.5 M silicate salt; and
0.15-2.0 M aluminium in the form of Al₂O₃
having an Al/Si ratio in the range from 2 to 20, and
a pH in the range from 0 to 3.

The concentration of the silicate in the liquid poly aluminium-silicate composition may vary depending on the specific purpose.

In an embodiment, the concentration of silicate in the poly aluminium-silicate composition is 0.2-1.5M, 0.25-1.5M, such as 0.3-1.5M, such as 0.35-1.5M, such as 0.4-1.5M, such as 0.45-1.5M, such as 0.5-1.5M, such as 0.6-1.5M,such as 0.7-1.5M, such as 0.8-1.5M, such as 0.9-1.5M, such as 1-1.5M, such as 1.1-1.5M such as 1.2-1.5M, such as 1.3-1.5M, such as 1.4-1.5M. In another embodiment, the concentration of silicate is 0.15-1.4M, such as 0.15-1.3M, such as 0.15-1.2M, such as 0.15-1.1M, such as, such as 0.15-1.0M, such as 0.15-0.5M. In a further embodiment, the concentration of silicate is 0.2-1.4M, 0.3-1.3M, 0.4-1.2M, 0.5-1.1M, 0.6-1.0M, 0.7-0.9M, or 0.7-0.8 M.

The choice of aluminum source will provide different properties to the liquid poly aluminium silicate composition, Thus, in an embodiment, the aluminum salt is selected from the group consisting of Al₂O₃, Al₂(SO₄)₃, AlCl₃, MAl(OH)ₓY (wherein M is a an alkali metal or earth alkali metal cation, X is the number of OH— groups and Y is an anion such as SO₄²⁻, Cl⁻, F⁻, PO₄³⁻). Preferably, the aluminum salt is selected from Al₂O₃, Al₂(SO₄)₃, or AlCl₃. More preferred preferably, AlCl₃.

Also, the specific concentration of the aluminium will depend on the specific purpose of the liquid poly aluminium-silicate PASC PRECURSOR composition. Thus, in an embodiment, the aluminium concentration is 0.2-2.0M, 0.25-2.0M, such as 0.3-2.0M, such as 0.35-2.0M, such as 0.4-2.0M, such as 0.45-2.0M, such as 0.5-2.0M, such as 0.6-2.0M,such as 0.7-2.0M, such as 0.8-2.0M, such as 0.9-2.0M, such as 1-2.0M, such as 1.1-2.0M such as 1.2-2.0M, such as 1.3-2.0M, such as 1.4-2.0M, or 1.5-2.0M. In another embodiment, the aluminium concentration is 0.15-1.75M, such as 0.15-1.5M, such as 0.15-1.25M, such as 0.15-1.0M, such as, such as 0.1.5-0.75M, such as 0.06-0.5M. In a further embodiment, the aluminium concentration is 0.25-1.75M, 0.5-1.5M, 0.75-1.25M, or 1.0-1.25M. In a preferred embodiment, the aluminium concentration is 1.5-2M.

The Al/Si ratio is important to the coagulation properties of the liquid poly aluminium-silicate composition and may be adjusted to the specific use as e.g. a coagulant. Thus, in an embodiment the Al/Si ratio is 3-20, such as 4-20, such as 5-20, 6-20, such as 7-20, such as 8-20, such as 9-20, such as 10-20. In another embodiment the Al/Si ratio is 2-19, such as 2-18, 2-17, 2-16, 2-15, 2-14, 2-13, 2-12, 2-11, or 2-10. In a preferred embodiment, the Al/Si ratio is 5-15.

The pH range of the liquid poly aluminum silicate PASC PRECURSOR composition may vary depending on the specific further use of the composition. Thus, in an embodiment the pH range is 1-3, such as 2-3 or in the pH range is 0-2, or 0-1. Preferably, the pH range is 1-2.

Use of the Poly Silicate Compositions

As mentioned above, coagulation is a common process in water treatment for destabilizing organic and inorganic impurities and producing large floc aggregates, which can subsequently be removed by clarification and/or filtration processes.

The present liquid PASC compositions, having a higher concentration than conventional PASC compositions and being more stable for storage, are useful as coagulants or flocculants in the treatment of water, such as drinking water, water in swimming pools, waste water, etc.

Thus, in an aspect, the present invention relates to the use of the PASC compositions according to the present invention as a coagulant.

In an embodiment, the coagulate is organic material. According to another embodiment, the coagulate is inorganic material.

According to a further embodiment, a PASC composition according to the present invention is used for water purification such as drinking water purification and waste water purification.

Use of the liquid poly silicate PRECURSOR composition for preserving cellulosic material.

The liquid poly silicate compositions according to the present invention may find use in other applications. Thus, it is well known that that e.g. sodium silicate may improve preservation of cellulosic materials, such as wood. Thus, the precursor composition obtained after step 2 (without aluminium, may be especially suited for that purpose).

Thus, in another aspect, the present invention relates to the use of a liquid poly silicate composition according to the present invention for preserving cellulosic material. Hence, the high concentration of the present liquid poly silicate composition is particular useful in preserving cellulosic material.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

Process for Producing PASC

Materials and Methods

Waterglass Type 46 (Bollerup-Jensen A/S), AlCl₃ (Sigma Aldrich p.a.), HCl(g) (Air Liquide, Compressed Air, NaOH (Sigma Aldrich)

Method

A water diluted alkaline sodium silicate solution having a formal Si concentration of 0.2-2.0 M, preferably 1.5 M, is added to a container under stirring, where controlled addition is possible. The silicate solution is slowly added to a reaction chamber, where the pH is maintained in the range 0-2, in order to prevent formation of silica gels. Control of pH is maintained via a pH electrode and a stream of HCl gas, which can be administered via a filter placed in the bottom of the reaction chamber. This configuration, in combination with efficient stirring and control of the volumetric flow rate of water glass addition, facilitates the safe formation of an acidified water glass composition with no impurities or precipitates. The reaction chamber is fitted with an outlet, which can be opened to keep the volume in the reaction chamber constant during continuous production of the acidified liquid. Furthermore, to the acidified product an solution of 2 M AlCl₃, (as aluminium ion source) or other ionic aluminium compound in solution, is added by liquid-liquid mixing, using an Al concentration calculated to reach a molar Al/Si ratio of 4-20 in the product mixture under stirring. Finally, the acidic Al-Si containing mixture is mixed under stirring with a conventional cheap alkaline material (KOH, NaOH or derivatives thereof) to reach a pH>11 and an OH/Al ratio in the range of 1-30. The final concentrated product may be used as a water cleaning product.

Results

By using the above process, a clear liquid product in a concentrated form of poly aluminium-silicate composite (e.g. PASC) is obtained (see example 2). The PASC PRECURSORS/intermediates are obtainable by the present process after the acidification step with a gaseous acid, i.e. poly silicate compositions (see example 3) and after acidification with a gaseous acid and addition of an aluminium source, i.e. poly aluminium-silicate compositions (see example 4).

Short Conclusion

The process according to the present invention makes it possible to obtain an attractive concentrated liquid form of PASC.

Supplementary experiments (data not shown) have shown that when an alkaline sodium silicate composition having a Si concentration above 2 M is used as starting material, the silicate will coagulate when acidified. Thus, the resulting PASC composition becomes solid (see also example 5 below).

### Example 2

Specific examples of poly aluminium-silicate composite (PASC) compositions

The following examples show compositions obtainable by the process described in example 1.

Composition 1

| Component | Concentration M |
|---|---|
| Si (total) | 0.157M |
| Aluminium (total) | 0.783M |
| Al/Si molar ratio | 5 |
| OH/Al molar ratio (B) | 0.32 |
| pH | 13.44 |

Composition 2

| Component | Concentration M |
|---|---|
| Si (total) | 0.0888M |
| Aluminium (total) | 0.888M |
| Al/Si molar ratio | 10 |
| OH/Al molar ratio (B) | 2.56 |
| pH | 13.55 |

Composition 3

| Component | Concentration M |
|---|---|
| Si (total) | 0.0515M |
| Aluminium (total) | 0.2625M |
| Al/Si molar ratio | 5 |
| OH/Al molar ratio (B) | 23.8 |
| pH | 12.8-13.6 |

Composition 4

| Component | Concentration M |
|---|---|
| Si (total) | 0.0279M |
| Aluminium (total) | 0.2797M |
| Al/Si molar ratio | 10 |
| OH/Al molar ratio (B) | 22.3 |
| pH | 12.8-13.6 |

Composition 5

| Component | Concentration M |
|---|---|
| Si (total) | 0.0279M |
| Aluminium (total) | 0.4195M |
| Al/Si molar ratio | 15 |
| OH/Al molar ratio (B) | 14.9 |
| pH | 12.8-13.6 |

### Example 3

Specific examples of liquid poly silicate PASC PRECURSOR compositions

The following examples show compositions obtainable by the process described in example 1 after lowering the pH with a gaseous acid.

Composition 6

| Component | Concentration M and % (w/w) |
|---|---|
| Si (total) | 1.5M |
| pH | 0.93 |
| Visual | Clear |

### Example 4

Specific examples of poly aluminium silicate PASC PRECURSOR compositions

The following examples show compositions obtainable by the process described in example 1 after lowering the pH with a gaseous acid and addition of an aluminium source.

Composition 7

| Component | Concentration M |
|---|---|
| Si (total) | 0.313M |
| Aluminium (total) | 1.565M |
| Al/Si molar ratio | 5 |
| pH | 1-3 |

Composition 8

| Component | Concentration M |
|---|---|
| Si (total) | 0.1777M |
| Aluminium (total) | 1.777M |
| Al/Si molar ratio | 10 |
| pH | 1.76 |

Example 5

Examples of the Effect of the Different Compositions.

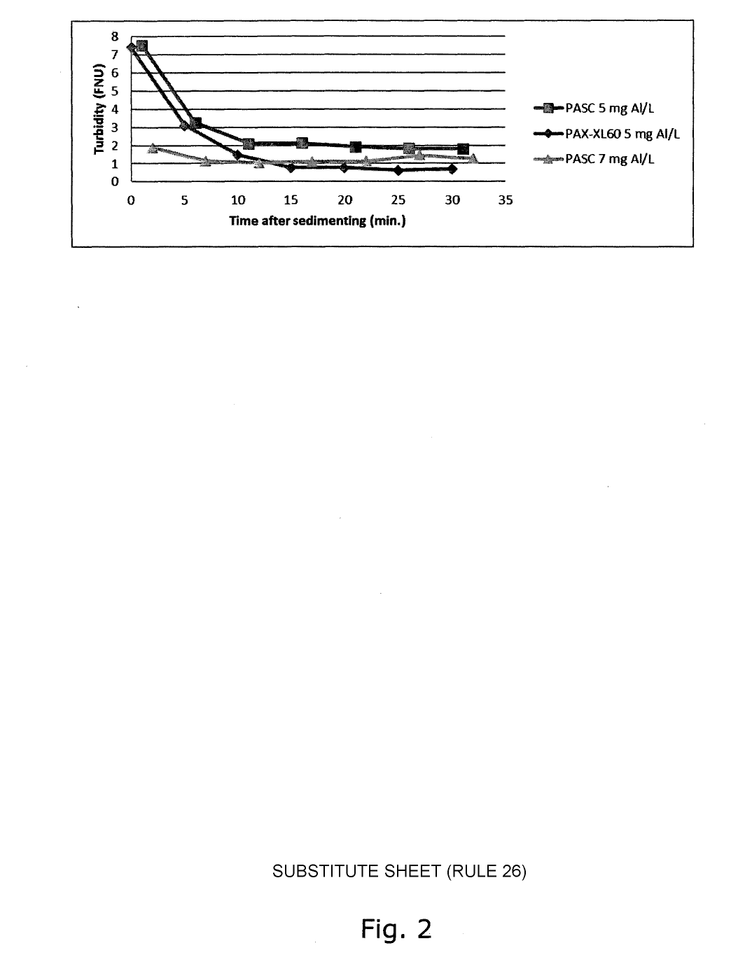

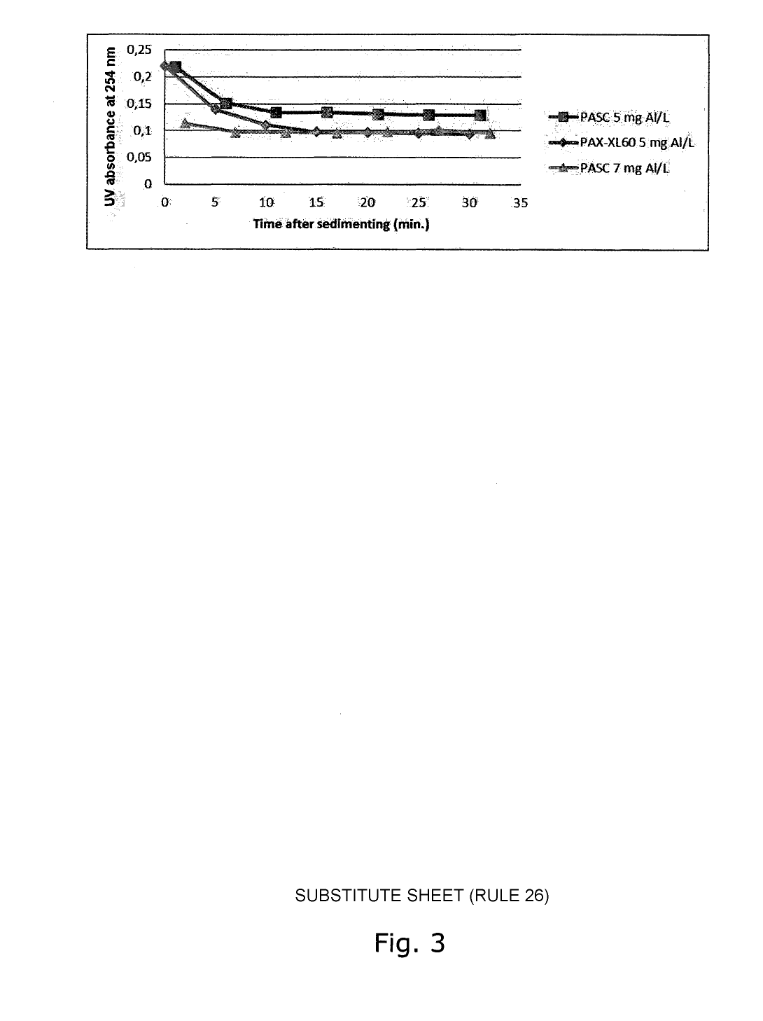

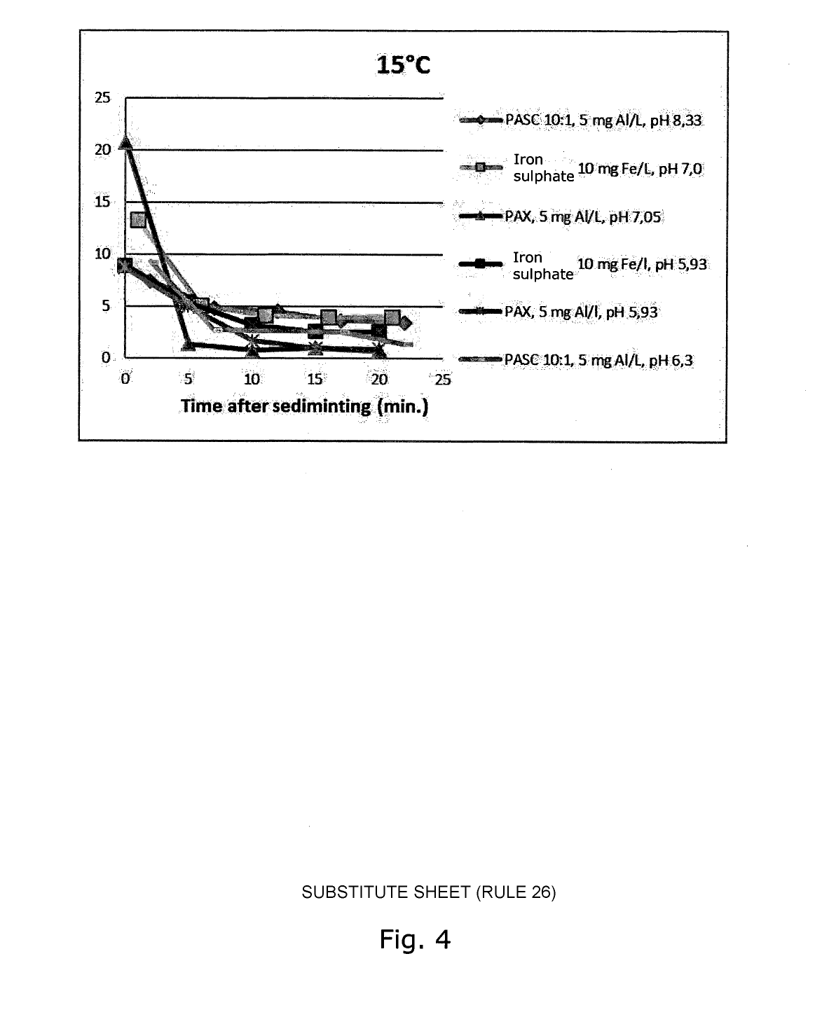

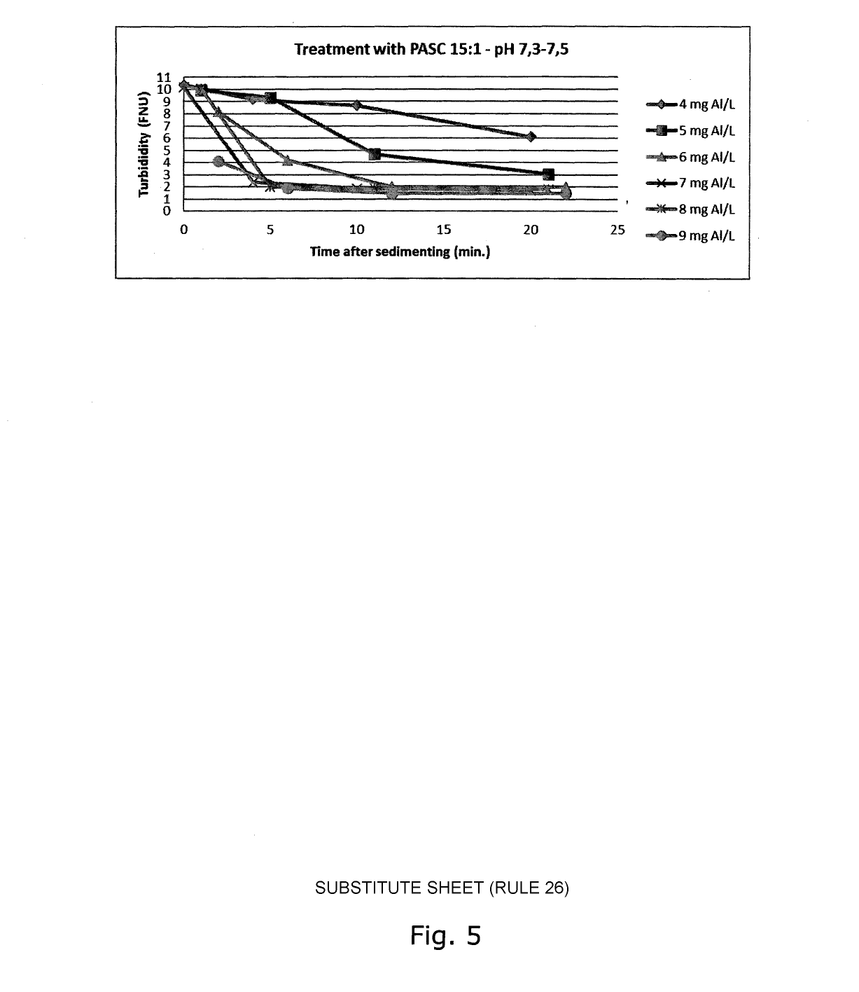

In evaluating the effect of PASC, two different parameters were used. Turbidity is an expression of the amount of flocculants dispersed in the water. A lower value means a clearer solution. UV absorbance at 254 nm is a commonly used indicator of the amount of organic matter dispersed in the water. A lower absorbance indicates less organic matter dispersed in the water. In evaluation the effect of PASC, it was compared to an “of the shelf” product. A widely used coagulant is PAX-XL60, a polyaluminiumchloride solution. Using PASCs compositions the effect of clearing natural lake water is shown in FIGS. 2-5.

Conclusion

As can be seen from FIGS. 2-5 the effect of PASC is comparable to commercial available polyaluminiumchloride when dosing the same amount of Aluminium. Since the PASC according to the invention is 30% more concentrated than the used PAX the usage of PASC is lower. Compared to ironsulfate the effect is better even when using only half the amount of aluminium.

### Example 6

Gao et al., (Chemosphere 46 (2002), pages 809-813) uses 40 ml of 0.25 M AlCl₃ ending up with a final concentration of 0.1 M Al. The final volume of PASC will then have to be 100 ml. Using 2.09-6.28 ml of a 0.3187 M Si solution in a final volume of 100 ml will result in a Si concentration in the final solution of 0.0067-0.02 M Si.

Based on the calculations, it is evident that the concentration range produced in the study is 0.0067 to 0.02 M Si and not as stated 0.0067-0.05 M Si.

### Example 7

Reference compositions according to Gao et al., Water Res. 2002 August; 36(14): 3573-81.).

For comparative purposes, the inventors intended to prepare and use the PASC compositions disclosed by Gao et al., Water Res. 2002 August;36(14):3573-81). Gao et al., Water Research 36 (2002), pages 3573-3581, teaches to prepare PASC compositions as follows. At first, 10.75 ml concentrated water glass (sodium silicate) solution (typically 3 M SiO₂) is introduced slowly into 10 ml 2M hydrochloric acid solution under stirred conditions to obtain a poly silicate solution.

However, this step would not seem to be reproducible, thus, it was found that when using a 3 M SiO₂, the solution will gelatinize or coagulate after addition of 5 out of the 10.75 ml into the 10 ml 2M hydrochloric acid, which correspond very well with our own findings performed under similar conditions, wherein gelatinized H₂SiO₃ is formed. Also, the pH would not seem to be lowered sufficient in this way.

Consequently, experiments were performed, wherein the reaction conditions and starting materials were changed in order to try to reproduce the results of Gao et al.

Thus, a 6 M SiO₂ solution was pre-neutralized to 3 M SiO₂ using either 2M or 3M hydrochloric acid. Thus, even though it was possible to pre-neutralize the silicate solution in this way, the pH was not lowered to below 3 in the subsequent addition of the 10.75 ml pre-neutralized 3M silicate solution to 10 ml 2M HCl resulting in gelatinization of the composition, i.e. the mixture became solid.

The addition of the 10.75 ml 3M silicate solution to the 10 ml 2M HCl solution was performed slowly at rate of 1 ml/min.

Finally, a corresponding experiment was performed, wherein a 6M SiO₂ solution was pre-neutralized to 3 M SiO₂ using 4M hydrochloric acid. Afterwards, 10.75 ml of the pre-neutralized 3 M SiO₂ solution was added slowly at a rate of 1 ml/min to 10 ml 2M hydrochloric acid, which however, also resulted in a gelatinized poly silicate composition.

Thus, it would not seem possible to reproduce the experiments performed by Gao et al. in this regard. Even if some optimization is performed. In particular, as is evident from the experimental examples above, it is not possible to prepare a liquid poly silicate composition having a concentration of 1.555M SiO₂ and a pH of 2.0-2.5, starting from a 10.75 ml 3M water glass solution and 10 ml 2 M HCl. Thus, the poly silicate composition obtained by this process would be gelatinized and have a pH above 8.

The second step is allegedly to either 1) mix the fresh poly silicate solution with 2.5 M AlCl₃ at a Al/Si ratio of 10 or more before adding concentrated Na₂CO₃ to obtain different basicities; or 2) by first slowly adding the concentrated Na₂CO₃ solution into the ALCl₃ under thorough stirring to obtain different poly aluminium chloride having B values (typically 7.70% Al₂O₃), then combine the PAC with the fresh poly silicate solution to obtain PASC coagulants having an Al/Si ratio of 10 or more.

However, as is evident from the experimental examples above, it is not possible to prepare a liquid poly silicate composition having a concentration of 1.555M SiO₂ and a PH of 2.0-2.5. Consequently, it would not be possible to perform the further steps because the poly silicate composition has already gelatinized.

1. A liquid poly aluminium-silicate chloride (PASC) composition comprising:
0.025-1 M silicium (Si);
0.05-2.0 M aluminium (Al);
an Al/Si molar ratio in the range of 2-20; and
a pH in the range of 10-14.

2-41. (canceled)

42. The composition according to claim 1, wherein the source of silicon is a silicate salt selected from the group consisting of sodium silicate, potassium silicate and lithium silicate.

43. The composition according to claim 1, wherein the concentration of silicon in the liquid PASC composition is in the range of 0.03-1M.

44. The composition according to claim 1, wherein the molar ratio between Cl⁻ and SO₄²⁻ is at least 10:1.

45. The composition according to claim 1, wherein the composition is free of or substantially free of SO₄²⁻.

46. The composition according to claim 1, wherein the aluminium concentration is in the range of 0.075-2M.

47. The composition according to claim 1, wherein the Al/Si ratio is in the range of 3-20.

48. The composition according to claim 1, having a basicity (OH/Al molar ratio; (B)) in the range of 1-30.

49. The composition according to claim 1, wherein the pH of the liquid PASC composition is in the range of 11-14.

50. A liquid poly aluminum-silicate chloride (PASC) composition comprising:
0.15-1.5 M silicon (Si);
0.3-3.0 M aluminium (Al);
having an Al/Si molar ratio in the range of 2 to 20; and
a pH in the range of 0 to 3.

51. The composition according to claim 50, wherein the concentration of silicon in the poly aluminium-silicate composition is in the range of 0.2-1.5M.

52. The composition according to claim 50, wherein the molar ratio between Cl⁻ and SO₄ is at least 10:1.

53. The composition according to claim 50, wherein the composition is free of or substantially free of SO₄²⁻.

54. The composition according to claim 50, wherein the aluminium concentration is in the range of 0.3-2.5 M.

55. The composition according to claim 50, wherein the Al/Si ratio is in the range of 3-20.

56. The composition according to claim 50, wherein the pH is in the range of 1-3.

57. A liquid poly silicate composition comprising:
0.5-2.0 M silicon (Si); and
having a pH in the range of 0 to 3.

58. The composition according to claim 57, wherein the source of silicon is a silicate salt selected from the group consisting of sodium silicate, potassium silicate and lithium silicate.

59. The composition according to claim 57, wherein the concentration of silicon in the liquid poly silicate composition is in the range of 0.6-2M.

60. The composition according to claim 57, wherein the pH of the liquid poly silicate composition is in the range of 1-3.

61. A process for preparing a liquid poly silicate composition, the process comprising:
a) providing a silicate solution having a concentration of silicon in the range of 0.7-1.9M,
b) lowering the pH of said silicate solution by a gaseous acid to a pH in the range of 0 to 3, and
c) providing a liquid poly silicate composition comprising 0.5-2.0 M Si and having a pH in the range of 0 to 3.

62. The process according to claim 61, further comprising a step d), said step d) comprising:
d) adding an aluminium source to the composition provided in step c; and
e) providing a liquid poly aluminium-silicate composition comprising:
0.15-1.5 M silicon (Si);
0.3-3.0 M aluminium;
having an Al/Si molar ratio in the range of 2 to 20; and
a pH in the range of 0 to 3.

63. The process according to claim 62, further comprising a step f), said step f) comprising:
4) raising the pH to above 10 in the composition provided in step c) by the addition of a base, and providing a liquid poly aluminium silicate composite comprising:
0.02-1 M silicon (Si);
0.04-2.0 M Aluminium (Al);
an Al/Si molar ratio in the range of 2-20; and
a pH in the range of 10-14.

64. The process according to claim 61, wherein the silicon is provided as a silicate selected from the group consisting of sodium silicate, potassium silicate and lithium silicate.

65. The process according to claim 61, wherein the concentration of silicon in the provided liquid polysilicate in step 2) is 0.6-1.5M.

66. The process according to claim 61, wherein the process is conducted in a continuous flow.
